(19) United States
(12) Patent Application Publication
(10) Pub. No.: US 2012/0228202 A1
(43) Pub. Date: Sep. 13, 2012

(54) SYSTEM FOR EXCLUDING AQUATIC ORGANISMS AND TRANSFER BACK TO A SOURCE WATERBODY

(75) Inventor: David Edward Bailey, Springfield, VA (US)

(73) Assignee: ELECTRIC POWER RESEARCH INSTITUTE, INC., Charlotte, NC (US)

(21) Appl. No.: 13/412,114

(22) Filed: Mar. 5, 2012

Related U.S. Application Data
(60) Provisional application No. 61/449,963, filed on Mar. 7, 2011.

(51) Int. Cl. E02B 5/08; B01D 35/02

(52) U.S. Cl. 210/155; 210/162

(57) ABSTRACT

An aquatic organism removal system includes a screen system and a return system. The screen system is adapted to separate aquatic organisms from cooling water entering a cooling water intake of a power producing facility and includes a screen intake and a screen exit downstream of the screen intake. The return system is connected to the screen exit and is adapted to receive the aquatic organisms and transfer the aquatic organisms safely to a source waterbody. When the cooling water and aquatic organisms enter the screen intake, the cooling water flows through the screen system and into the cooling water intake of a power producing facility and the aquatic organisms flow out the screen exit and into the return system.

This application claims the benefit of Provisional Application No. 61/449,963 filed on Mar. 7, 2011.

### BACKGROUND OF THE INVENTION

The present invention relates to a system for excluding aquatic organisms from entering an intake of a power producing facility, and more particularly to a system that removes aquatic organisms from the intake and transfers them back to a safe zone in a source waterbody.

There are a variety of fish protection technologies to reduce fish impingement (fish that will not pass through 9 mm traveling screens designed to keep fish and debris from clogging the condenser tubes). However, currently there is a somewhat limited array of alternative fish protection technologies available to prevent entrainment (i.e. small fish and shellfish eggs and larvae passing through the traveling screens).

The Environmental Protection Agency (EPA) is in the process of developing regulations for Section 316(b) of the Clean Water Act. Section 316(b) requires power plants to minimize adverse environmental impact to fish and other aquatic life as a result of the design, location, construction and capacity of the cooling water intake structure. It is estimated that 39 nuclear facilities and 389 fossil facilities may be affected by the EPA's 316(b) regulations. In addition, the regulations are expected to set technology requirements for other industries as well. Should the EPA designate closed-cycle cooling as BTA for 316(b), any alternative fish protection technologies will need to have a high level of performance (i.e. expected to be in excess of 80%).

Currently, other than cooling towers, the most effective entrainment reduction technologies are exclusion devices such, as narrow-slot wedgewire screens and the aquatic filter barrier (AFB). These technologies rely on a low through screen velocity that does not exceed 0.5 fps and narrow-slot screen or mesh spacing (as narrow as 0.5 mm) to exclude entrainable life stages from the cooling system. However, to achieve the low through screen velocity requires a relatively large surface area resulting in a large size and/or number of wedgewire screen modules to achieve the low velocity. Further, these systems, in marine environments, require biofouling control and traditional fouling control methods are impractical for offshore ocean intakes. In other instances the technology has been found to be infeasible due to impacts to water navigation.

### BRIEF SUMMARY OF THE INVENTION

Accordingly, there is a need for an aquatic organisms system that overcomes the deficiencies of the prior art.

According to an aspect of the invention, an aquatic organism removal system includes a screen system and a return system. The screen system is adapted to separate aquatic organisms from cooling water entering a cooling water intake of a power producing facility and includes a screen intake and a screen exit downstream of the screen intake. The return system is connected to the screen exit and is adapted to receive the aquatic organisms and transfer the aquatic organisms safely to a source waterbody. When the cooling water and aquatic organisms enter the screen intake, the cooling water flows through the screen system and into the cooling water intake of a power producing facility and the aquatic organisms flow out the screen exit and into the return system.

According to another aspect of the invention, an aquatic organism removal system includes a containment housing connected to a cooling water intake of a power producing facility, a screen system contained in the housing and adapted to separate aquatic organisms from cooling water received from a source waterbody, and a return system connected to an exit of the screen system and adapted to receive and transport the aquatic organisms back to the source waterbody. The cooling water enters the screen system, the cooling water flows through apertures in the screen and into the cooling water intake of the power producing facility while the aquatic organisms are removed from the cooling water by the screen system and transported through the return system to the source waterbody.

### BRIEF DESCRIPTION OF THE DRAWINGS

The subject matter that is regarded as the invention may be best understood by reference to the following description taken in conjunction with the accompanying drawing figures in which:

FIG. 1 shows a section view of a prior art Modular Inclined Screen (MIS) system;

FIG. 2 shows a plan view of the prior art MIS system of FIG. 1;

FIG. 3 is a plan view of a prior art Eicher system;

FIG. 4 is a side view of the system of FIG. 3;

FIG. 5 shows a prior art wedgewire V screen system;

FIG. 6 is a plan view of an aquatic organism removal system according to an embodiment of the invention;

FIG. 7 is a section view of the system of FIG. 6;

FIG. 8 is a plan view of an aquatic organism removal system according to an embodiment of the invention; and

FIG. 9 is a section view of the system of FIG. 8.

### DETAILED DESCRIPTION OF THE INVENTION

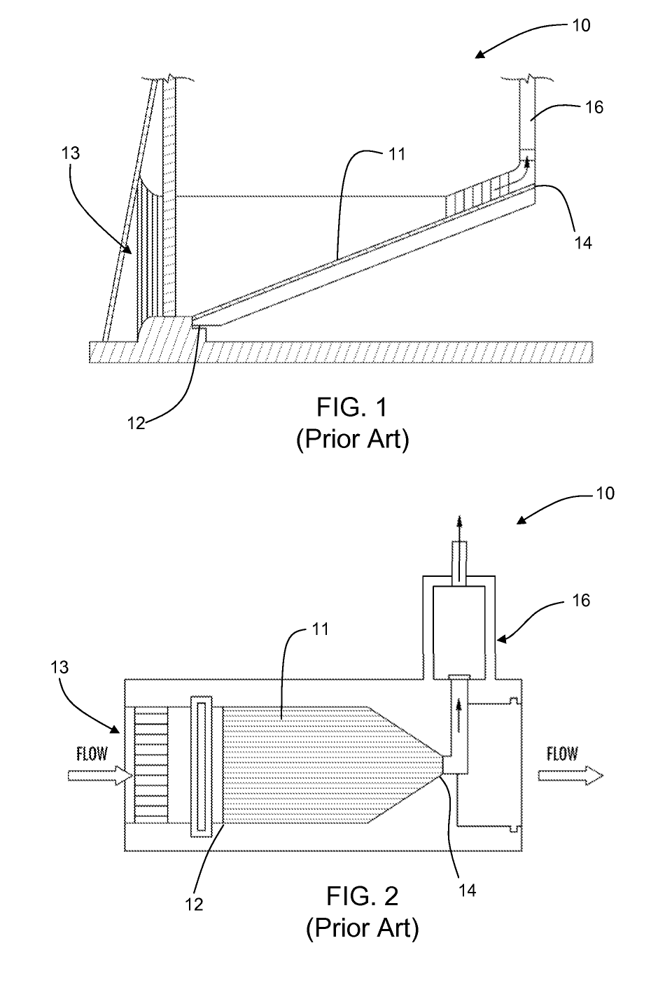

Referring to FIGS. 1 and 2, the present invention builds on an existing fish protection technology identified as a Modular Inclined Screen (MIS) 10. The MIS technology consists of a single flat panel inclined wedgewire screen 11 having an upstream end 12 that rests on a bottom of an intake 13 and rises at a 10-20 degree angle downstream, such that the downstream end 14 rises above the waterline.

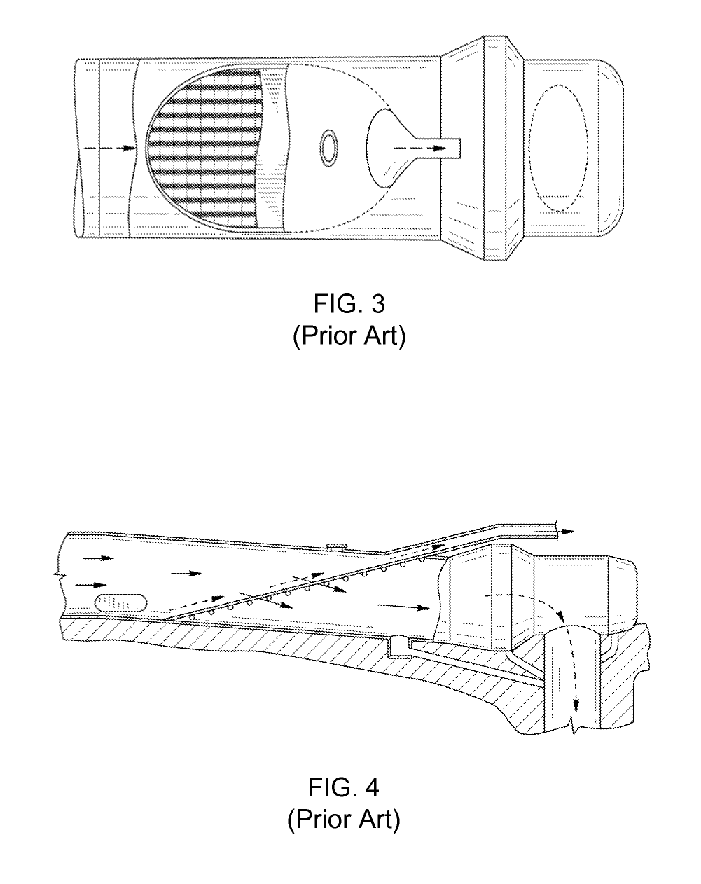

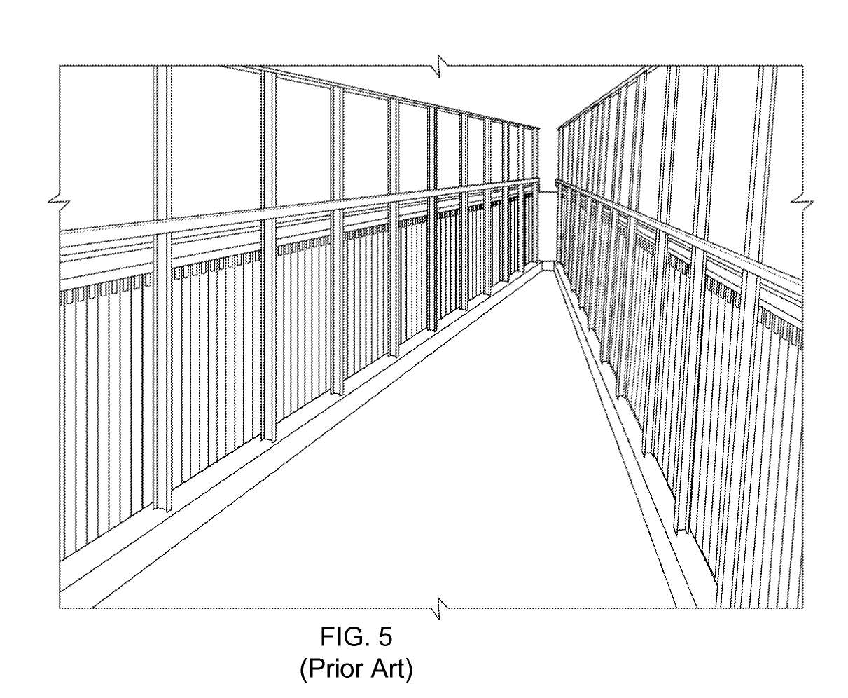

Organisms that are too large to pass through the screen 11 are pushed by the cooling water flow up the inclined screen 11 and are removed when they get near the surface of the screen 11 at the downstream end 14 for transport back to a source waterbody via a bypass 16. Cooling water passes through the wedgewire screen panel 11 and flows on to a condenser. The screen 11 has been tested at a 2 mm slot width and was found to be very effective in reducing mortality compared to conventional traveling screens to impingeable sized organisms, with no testing done on entrainable life stages. However, to date, the MIS system 10 has never been deployed at a power plant. Other prior art systems such as the Eicher system, FIGS. 3 and 4, and a V screen system, FIG. 5, have also been developed.

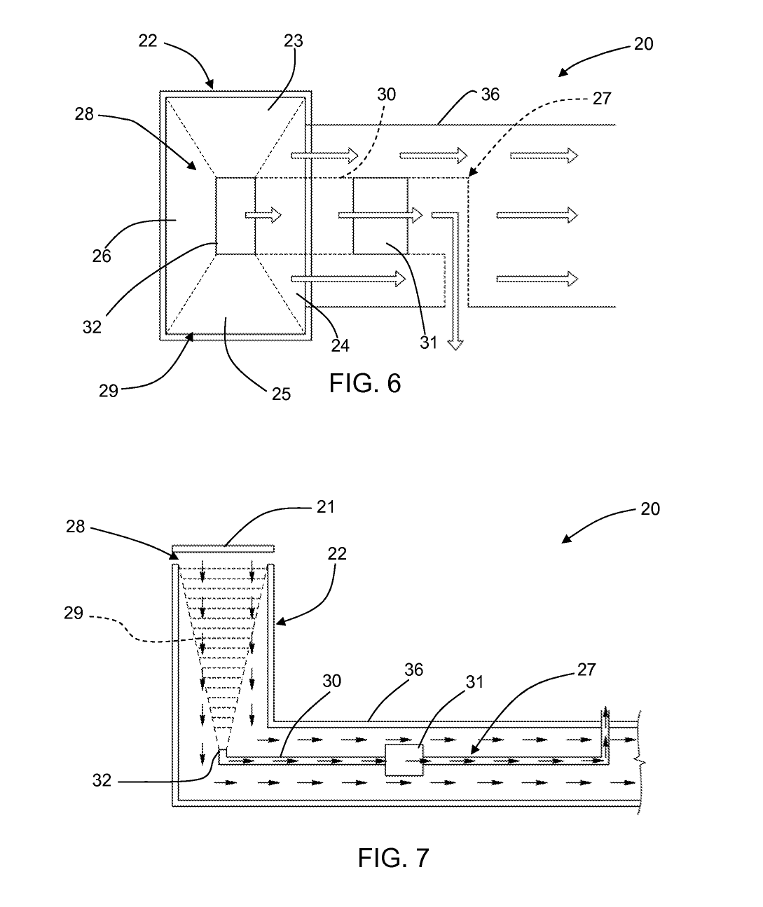

Referring now to FIGS. 6 and 7, an aquatic organism removal system according to an embodiment of the invention is illustrated generally at reference numeral 20. The system 20 includes four main components: (1) bar rack or exclusion bars 21; (2) wedgewire screen containment structure or housing 22; (3) wedgewire screen system 29 formed by wedgewire screens 23-26; and (4) fish and debris return system 27. The bar rack 21 is used to prevent large debris, marine mammals and or large fish and other aquatic organisms from entering and clogging the system 20, and more particularly to prevent entry of such objects into the wedgewire screen containment structure 22. The bar spacing is sized to ensure that objects too large to pass through the fish and debris return system 27 do not enter the containment structure 22. Generally the bar racks 21 include a plurality of parallel steel bars spaced approximately 2 to 4 inches apart. For power plants with offshore intakes and velocity caps, bars spaced about 9 inches apart may be used to prevent entry of marine mammals and sea turtles.

The containment structure or housing 22 houses the wedgewire screen system 29 and connects to an intake tunnel that provides cooling water to power plant condensers. The cooling water passes through the wedgewire screen system 29 while fish and debris are excluded from the passing cooling water and directed into the fish and debris return system 27 located downstream of the wedgewire screen system 29. The housing is preferably made of concrete or steel and has an opening 28 that could be either square, round or rectangular in shape, depending on the waterbody type and water depth at the point of deployment. Further, the housing 22 may include its own intake tunnel 36 which connects to a power producing facility's intake tunnel or the housing 22 may only include enough structure to contain the wedgwire screen system 29 and then utilize the intake tunnel of the power producing facility for housing the rest of the system 20.

The wedgewire screen system 29 is formed by wedgewire screens 23-26 which are of a narrow-slot type to exclude impingeable and entrainable fish and shellfish and direct them to the fish return system 27. The narrow-slot wedgewire screens 23-26 are sized to be small enough to exclude entrainable life stages of fish and shellfish at a power plant. The slot width of the screens 23-26 range from 0.5 mm to 2 mm depending on the size and species to be protected (this varies on a site specific basis). The wedgewire screens 23-26 are abutted up against each other to form the wedgewire screen system 29 and create an uninterrupted circumference to eliminate gaps therebetween. Further, the screens 23-26 are inclined to converge at a fish and debris collection return entry point 32. It should be appreciated that the wedgewire screen system 29 and uninterrupted circumference may be formed by a single screen section, multiple screen sections (as shown), or a combination of screen and non-screen sections. One can visualize these screens 23-26 in the shape of a pyramid that is cut off at the top, such that the cut off top is the point of entry into the fish return system 27. The entire system 20 is submerged.

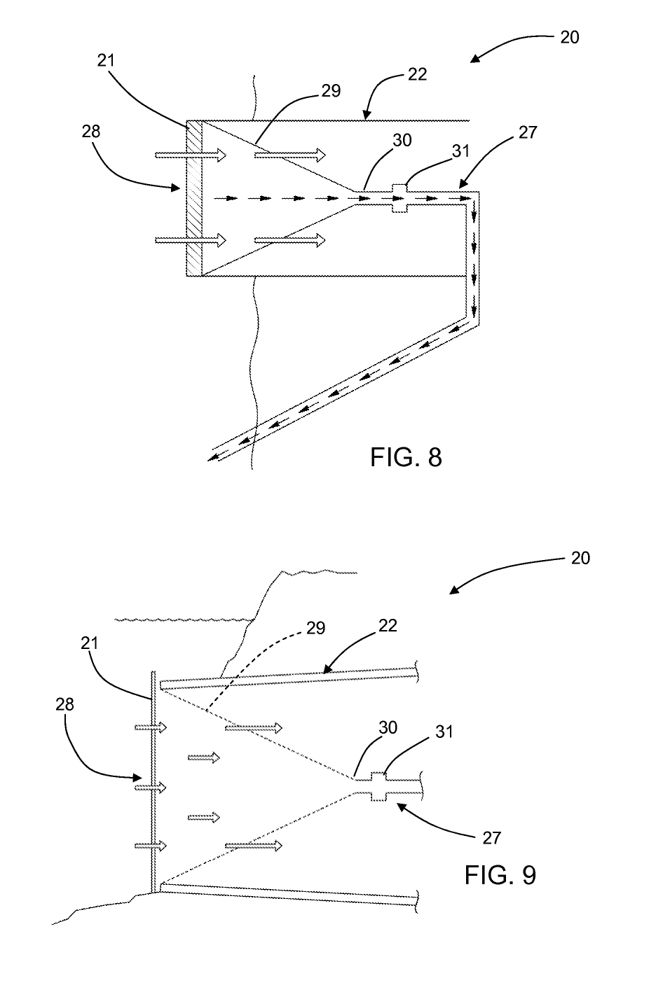

As shown, the pyramid is inverted for an offshore deployment or may be used horizontally, as shown in FIGS. 8 and 9, for a shoreline deployment. It should also be appreciated that while the shape has been described as a pyramid, the shape may also take the form of a funnel (i.e. circular) or a rectangle for a shoreline intake in shallower water. In addition, it should be appreciated that a single wedgewire screen formed to a desired shape could be used instead of multiple screens.

The fish and debris return system 27 transfers fish, shellfish, and debris back to the source waterbody and is located downstream of the wedgewire screen system 29 and in the center of the cooling water pipe or tunnel 36. As discussed above, the fish and debris return system 27 may also be locate0d in a power producing facility's existing intake tunnel. The return location would be as short as possible but outside the hydraulic zone of influence of the cooling water intake. The system 27 includes two subcomponents: (1) a fish return pipe 30; and (2) a fish friendly pump 31. The fish return pipe 30 is used to return the fish to the source waterbody. The inside of the pipe 30 is coated with a super slick material. This would have several advantages.

The first advantage is that the size of the pump 31 required could be reduced as a result of less friction of water moving through the pipe 30. The second advantage is that it would be more resistant to biofouling. In marine environments, in particular, attached biofouling organisms can prey on fish eggs and larvae. For facilities that have offshore intake, predation on aquatic organisms moving through the offshore intake tunnels has been found to be significant. Such organisms have difficulty attaching to super slick coatings. The third advantage of the super slick coating is that it could reduce stress on entrainable life stages that might come into contact with the pipe 30 as they pass through. The diameter of the pipe 30 is sized large enough to accommodate impingeable sized fish and debris passing through the bar rack 21.

The discharge of the fish return pipe 30 would be located at a point that would minimize the risk of re-impingement or entrainment at an intake of a facility. On a river this would be downstream of the intake. For a lake, reservoir, estuary or tidal river it would be outside the cooling water intake hydraulic zone of influence (HZI). For an offshore intake it could be located closer inshore outside the HZI. In general, the pipe 30 should be as short as possible in order to return fish outside the HZI and minimize potential stress during transport through the pipe 30.

The pump 31 provides the necessary flow of water in the fish return pipe 30 to transport fish and debris back to the source waterbody. The pump 31 would be sized to accommodate the necessary flow though the pipe 30 and the size of the organisms and debris passing through the bar rack 21.

There are several potential advantages of the present invention over the prior art. Since there is 4 rather than 1 inclined screen panel, in the present invention, the overall size of each of the screens would be only about 25% of the single MIS panel. This means that the size of the narrow-slot wedgewire screen housing could be reduced in size. Because the length of each of the four inclined screens would be significantly reduced compared to the single MIS panel, the contact time of any organisms passing along the screens with the flow would be significantly reduced, reducing risk of entrainment mortality that may result from screen contact. Also, the system could be deployed offshore to accommodate a number of power plants with offshore intakes.

The result is that compared to conventional narrow-slot wedgewire screen modules, there would be significant economic advantages. Since the system does not depend on a low through screen velocity, significantly less wedgewire screen hardware is required. This would also reduce the system operating and maintenance (O&M) cost. Another advantage of the present invention over cylindrical wedgewire screen is damage prevention. Since cylindrical wedgewire screen modules are placed in the open water, they are exposed to damage by ice, large debris (i.e. tree trunks) or hydraulic forces during storm events in oceans with offshore deployment. Since the present invention houses the wedgewire screens in a concrete or steel housing structure they are protected from open water damage by large objects and/or hydraulic forces.

One of the major concerns for most power plants is debris control to prevent loading and clogging. In shore power plants control large debris with trash racks. However, for a few power plants with offshore intakes and velocity caps, ex. SONGS, there are no offshore bar racks (there are inshore bar racks to protect the traveling screens), so debris such as kelp is a major concern.

For fish and smaller debris passing through the bar racks, as noted, the diameter of the fish and debris return pipe and fish friendly pump would be sized to allow transport of that material back to the source waterbody. However, power plant operators, particularly for nuclear plants, are likely to be concerned in terms of adequate fail safe measures. The concern here is that if the entry to the fish return system becomes clogged, debris will build up inside the wedgewire screen panels with potential to block sufficient wedgewire screen surface area to obstruct cooling water flow to the condensers. For fossil facilities this could result in an outage and for nuclear facilities could result in a major safety concern.

Some debris control solutions include lifting the wedgewire screen plate, retaining existing intake screens as backup, back-flushing, and redundancy. For an inshore screen deployment a motor could be installed to lift one or more inclined wedgewire screen plate(s). The lift mechanism would be attached at the downstream end of the plate (the narrow end) where it meets the intake port of the fish return system. By raising the plate, accumulated debris would then pass into the condenser cooling water intake pipe where it could be dealt with downstream at the traveling screens (assuming the screens were retained with the design). Note that while prior discussion has described the housing structure as an enclosed system, for shoreline or inshore deployments the containment structure could be open on top. In this option a curtain wall could be installed near the surface with an open area underneath for water flow. The wedgewire screens could be installed flush with the curtain wall opening on the back side of the curtain wall such that they would always be submerged. The open channel behind the curtain wall could provide easier access for maintenance to the screens and fish pump as needed. As noted, if a lift is employed to allow periodic debris by-pass traveling screens would be necessary downstream to prevent condenser tube and tube sheet face blockage.

The present invention could also be deployed with the existing intake screens retained as a back up. In this option the new system would tie into the cooling water intake conduit downstream of the exiting intake traveling screens. In the event of blockage, a valve system would switch to allow cooling water to come from the prior intake and the present invention would remain out of service until the blockage was removed.

Most plants also have the capability to backflush cooling water. If condenser back pressure builds to a pre-determined point back-flushing is triggered to remove the debris.

The present invention may also be used in a redundant configuration where two or more systems are installed with the capability to alternate between systems, such that if one clogs the other(s) can be used while the blockage is removed.

Another major concern is biofouling control. Biofouling of intakes is a major concern for facilities located on oceans, estuaries and tidal rives and can also be an issue for freshwater facilities due to zebra mussels, Asian clams and other biofouling organisms. Biofouling presents two major issues (1) reduced heat transfer in the condensers and (2) mats of biofouling organisms breaking off intake tunnels and block the condenser tube sheet face. At most power plants biofouling is controlled with chlorine injected behind the traveling screens to keep intake tunnels free of fouling. One option for controlling biofouling in the present invention is to use Biocides—Chlorine or another oxidant could be injected downstream of the wedgewire screens to control fouling in the cooling water tunnels and condensers as in the current practice. However, this option is not likely to be viable for the wedgewire screen due to resulting fish mortality. Another option is to chlorinate the fish return line on an intermittent basis since the amount of chlorine required would be significantly less than for the intake tunnels and condensers.

Other approaches include (1) coating the wedgewire screen with a super slick coating as discussed for the fish return pipe to discourage attachment of fouling organisms and (2) heat treating where a reverse flow is used to send the heated discharge water out through the intake to control fouling in the intake tunnels. This could also be done by recirculating hot water for ice control at the intake. A hot water line could be used to control fouling of the wedgewire screen plates. A third approach is to do mechanical cleaning such as the use of brushes.

As with any new technology, cost is always a factor when deciding whether to implement the new technology. In comparison to existing technologies, because of the smaller housing system required in the present invention, it is estimated that the present invention will have a cost less than half of that associated with a 2 mm slot modular wedgewire screen system and likely less than a 2 mm MIS system. See Table 1.

TABLE 1
Cost Comparison of Evaluated Alternatives

| | | Replacement | | | | | | Total |
|---|---|---|---|---|---|---|---|---|
| | | Power Cost | Total | | | Annualized | Incremental | Incremental |
| | | During | Capital | O&M | Annual | Capital | Annualized | Annualized |
| | Construction | Construction | Cost | Costs | Energy | Costs | O&M Costs | Costs |
| Technology | Costs (2008) | (2008) | (2008) | (2008) | (MWh) | (2008) | (2008) | (2008) |
| IM&E Options | | | | | | | | |
| Fine-mesh | $21,323,000 | $56,299,000 | $77,622,000 | $1,577,000 | 1,616 | $11,052,000 | $1,301,000 | $12,353,000 |
| Modified | | | | | | | | |
| Traveling | | | | | | | | |
| Screens in a | | | | | | | | |
| new | | | | | | | | |
| Screenhouse | | | | | | | | |
| 0.5 mm | $23,553,000 | $75,065,000 | $98,618,000 | $609,000 | 1,437 | $14,041,000 | $336,000 | $14,377,000 |
| Wedgewire | | | | | | | | |
| Screens | | | | | | | | |
| IM Only | | | | | | | | |
| Options | | | | | | | | |
| Coarse-mesh | $5,725,000 | $0 | $5,725,000 | $852,000 | 1,459 | $815,000 | $576,000 | $1,391,000 |
| Modified | | | | | | | | |
| Traveling | | | | | | | | |
| Screens⁴ | | | | | | | | |
| 2.0 mm | $11,241,000 | $56,299,000 | $67,540,000 | $297,000 | 438 | $9,616,000 | $21,000 | $9,637,000 |
| Wedgewire | | | | | | | | |
| Screens | | | | | | | | |
| 9.5 mm | $10,418,000 | $56,299,000 | $66,717,000 | $215,000 | 248 | $9,499,000 | ($61,000) | $9,438,000 |
| Wedgewire | | | | | | | | |
| Screens | | | | | | | | |
| Modular | $12,635,000 | $18,766,000 | $31,401,000 | $889,000 | 3,573 | $4,471,000 | $613,000 | $5,084,000 |
| Inclined | | | | | | | | |
| Screens | | | | | | | | |
| Existing | $0 | $0 | 0 | $276,000 | 259 | $0 | $0 | $0 |
| Operations⁵ | | | | | | | | |

The foregoing has described a system for excluding aquatic organisms and transfer back to a source waterbody. While specific embodiments of the present invention have been described, it will be apparent to those skilled in the art that various modifications thereto can be made without departing from the spirit and scope of the invention. Accordingly, the foregoing description of the preferred embodiment of the invention and the best mode for practicing the invention are provided for the purpose of illustration only and not for the purpose of limitation.

I claim:

1. An aquatic organism removal system, comprising:
(a) a screen system adapted to separate aquatic organisms from cooling water entering a cooling water intake of a power producing facility, the screen system including a screen intake and a screen exit downstream of the screen intake; and
(b) a return system connected to the screen exit, the return system being adapted to receive the aquatic organisms and transfer the aquatic organisms safely to a source waterbody, wherein when the cooling water and aquatic organisms enter the screen intake, the cooling water flows through the screen system and into the cooling water intake of a power producing facility and the aquatic organisms flow out the screen exit and into the return system.

2. The aquatic organism removal system according to claim 1, wherein the screen system includes at least one screen of a narrow-slot type having a plurality of slots with a width of 0.5 mm.

3. The aquatic organism removal system according to claim 1, wherein the screen system includes at least one screen of a narrow-slot type having a plurality of slots with a width of 2 mm.

4. The aquatic organism removal system according to claim 1, wherein the screen system includes at least one screen of a narrow-slot type having a plurality of slots with a width ranging from 0.5 mm to 2 mm.

5. The aquatic organism removal system according to claim 1, wherein the screen system is contained in a housing constructed of concrete.

6. The aquatic organism removal system according to claim 1, wherein the screen system is contained in a housing constructed of steel.

7. The aquatic organism removal system according to claim 1, further including exclusion bars for preventing large aquatic organisms from entering the removal system.

8. The aquatic organism removal system according to claim 1, wherein the return system includes a return pipe connected to the screen exit for transferring the aquatic organisms to the source waterbody and a pump for moving water through the return pipe.

9. The aquatic organism removal system according to claim 8, wherein an inside of the return pipe is coated with a slick material to reduce friction inside the pipe and protect the aquatic organisms moving therethrough.

10. The aquatic organism removal system according to claim 1, wherein the screen system includes a plurality of screens abutted against each other to eliminate gaps therebetween, the plurality of screens are inclined to converge and form the screen exit.

11. An aquatic organism removal system, comprising:
(a) a containment housing connected to a cooling water intake of a power producing facility;
(b) a screen system contained in the housing and adapted to separate aquatic organisms from cooling water received from a source waterbody;
(c) a return system connected to an exit of the screen system and adapted to receive and transport the aquatic organisms back to the source waterbody; and
(d) wherein when the cooling water enters the screen system, the cooling water flows through apertures in the screen and into the cooling water intake of the power producing facility while the aquatic organisms are removed from the cooling water by the screen system and transported through the return system to the source waterbody.

12. The aquatic organism removal system according to claim 11, wherein the screen system includes a plurality of wedgewire screens abutted against each other to eliminate gaps therebetween, the plurality of screens are inclined to converge and form the exit connected to the return system.

13. The aquatic organism removal system according to claim 12, wherein the plurality of screens form an uninterrupted circumference at both an intake of the screen system and the exit of the screen system.

14. The aquatic organism removal system according to claim 11, wherein the screen system includes at least one wedgewire screen inclined to converge and form the exit connected to the return system.

15. The aquatic organism removal system according to claim 14, wherein the at least one screen forms an uninterrupted circumference at both an intake of the screen system and the exit of the screen system.

16. The aquatic organism removal system according to claim 11, wherein the screen system is of a pyramid shape having an intake and an exit, wherein the intake is larger than the exit.

17. The aquatic organism removal system according to claim 11, wherein the screen system is of a funnel shape having an intake and an exit, wherein the intake is larger than the exit.

18. The aquatic organism removal system according to claim 11, wherein the return system includes a return pipe connected to the exit of the screen system for transferring the aquatic organisms to the source waterbody and a pump for moving water through the return pipe.

19. The aquatic organism removal system according to claim 18, wherein an inside of the return pipe is coated with a slick material to reduce friction inside the pipe and protect the aquatic organisms moving therethrough.

20. The aquatic organism removal system according to claim 11, further including exclusion bars for preventing large aquatic organisms from entering the removal system.
